(19) United States
(12) Patent Application Publication
(10) Pub. No.: US 2024/0272748 A1
(43) Pub. Date: Aug. 15, 2024

(54) DISPLAY CONTROL METHOD, DISPLAY DEVICE AND READABLE STORAGE MEDIUM

(71) Applicants: Nanjing BOE Display Technology CO., LTD, Nanjing, Jiangsu (CN); BOE TECHNOLOGY GROUP CO., LTD., Beijing (CN)

(72) Inventors: Dayu Zhang, Beijing (CN); Yueyuan Zhang, Beijing (CN); Yaokun Zheng, Beijing (CN); Tunghsin Lan, Beijing (CN)

(73) Assignees: NANJING BOE DISPLAY TECHNOLOGY CO., LTD, Nanjing, Jiangsu (CN); BOE TECHNOLOGY GROUP CO., LTD., Beijing (CN)

(21) Appl. No.: 18/023,419

(22) PCT Filed: Apr. 21, 2022
(86) PCT No.: PCT/CN2022/088128

§ 371 Date: Feb. 27, 2023

(51) Int. Cl. G06F 3/041; A63F 13/2145; G09G 5/00

(52) U.S. Cl. CPC G06F 3/04184; G09G 5/003; A63F 13/2145; G09G 2310/08; G09G 2340/0435; G09G 2354/00

(57) ABSTRACT

The present disclosure provides a display control method, a display device, and a readable storage medium. A display control method, applied to a display device, including: obtaining a display refresh frequency of the display device, the display refresh frequency includes a first refresh frequency and a second refresh frequency, and the first refresh frequency is greater than the second refresh frequency; determining a touch control sampling frequency corresponding to the display device according to the display refresh frequency, the touch control sampling frequency includes a first sampling frequency corresponding to the first refresh frequency and a second sampling frequency corresponding to the second refresh frequency, and the second sampling frequency is greater than the first sampling frequency; driving the display device to display an image according to the determined display refresh frequency, and collecting touch control information according to the touch control sampling frequency.

### TECHNICAL FIELD

Embodiments of the present disclosure relate to the field of display, and in particular, to a display control method, a display device, and a readable storage medium.

### BACKGROUND

An embedded-in touch control display panel (In cell Touch Panel) is a display panel in which a touch control electrode is embedded inside the display panel so as to realize a touch control function. For such an in-cell touch panel, the timing sequences for image display and touch control scanning are conflicting, namely, the touch control scanning cannot be performed in a period for image display in which a pixel charging operation is performed, and the pixel charging operation cannot be performed in a period for the touch control scanning.

### SUMMARY

In a first aspect, embodiments of the present disclosure provide a display control method, applied to a display device, the method including the steps of:
obtaining a display refresh frequency of the display device, wherein the display refresh frequency comprises a first refresh frequency and a second refresh frequency, and the first refresh frequency is greater than the second refresh frequency;
determining a touch control sampling frequency corresponding to the display device according to the display refresh frequency, wherein the touch control sampling frequency comprises a first sampling frequency corresponding to the first refresh frequency and a second sampling frequency corresponding to the second refresh frequency, and the second sampling frequency is greater than the first sampling frequency; and
driving the display device to display an image according to the determined display refresh frequency, and collecting touch control information according to the touch control sampling frequency.

In some embodiments, the first sampling frequency is 0, the first refresh frequency is greater than 0, and in a case where the refresh frequency is the first refresh frequency, an operation timing sequence of the display device comprises a plurality of picture refresh periods arranged sequentially, and one frame of operation timing sequence of the display device corresponds to one picture refresh frame.

In some embodiments, the touch control sampling frequency is greater than 0, the display refresh frequency is greater than 0, and one frame of operation timing sequence of the display device comprises picture refresh periods and touch control scanning periods which are alternately arranged, and all the picture refresh periods in the one frame of operation timing sequence of the display device correspond to one picture refresh frame.

In some embodiments, before the obtaining a display refresh frequency of the display device, the method further includes:
obtaining an operation mode of the display device; and
the obtaining a display refresh frequency of the display device includes:
obtaining the display refresh frequency corresponding to the operation mode.

In some embodiments, the obtaining an operation mode of the display device includes:
determining that the operation mode of the display device is a non-touch control display mode in a case that one of the following conditions is satisfied:
an operation input provided based on a first type of peripheral device is detected;
an operation input to turn off a touch control function is received; or
a first type of application is detected to be in a running state.

In some embodiments, the first type of peripheral device comprises one or more of the following: a mouse, a keyboard, or a game peripheral device.

In some embodiments, the first type of application comprises one or more of a game program or a video player.

In some embodiments, the obtaining an operation mode of the display device includes:
determining that the operation mode of the display device is a touch control display mode in a case that one of the following conditions is satisfied:

an active stylus is detected to be in an operation state;
an operation input for turning on a touch control function is detected;
an action of a touch control input is detected by a camera; or
a second type of application is detected to be in a running state.

In some embodiments, the second type of application includes one or more of a document processing program and a drawing program.

In some embodiments, the touch control display mode comprises a first touch control display mode and a second touch control display mode, a touch control sampling frequency corresponding to the first touch control display mode and a touch control sampling frequency corresponding to the second touch control display mode are both greater than 0, and a display refresh frequency corresponding to the first touch control display mode and a display refresh frequency corresponding to the second touch control display mode are different.

In some embodiments, the display device is in the first touch control display mode in a case that the display refresh frequency of the display device is in a first refresh frequency range, and the display device is in the second touch control display mode in a case that the display refresh frequency of the display device is in a second refresh frequency range, and the first refresh frequency range and the second refresh frequency range do not overlap.

In some embodiments, for the first touch control display mode and the second touch control display mode, a ratio of duration of a picture refresh period to duration of a touch control scanning period in each frame of operation timing sequence of the display device is different.

In some embodiments, a display refresh frequency corresponding to the first touch control display mode is greater than a display refresh frequency corresponding to the second touch control display mode, and in each frame of operation timing sequence of the display device, a ratio for a touch control scanning period corresponding to the first touch control display mode is less than a ratio for a touch control scanning period corresponding to the second touch control display mode.

In a second aspect, embodiments of the present disclosure provide a display device including:
a display refresh frequency determination module, configured for obtaining a display refresh frequency of the display device, wherein the display refresh frequency comprises a first refresh frequency and a second refresh frequency, and the first refresh frequency is greater than the second refresh frequency;
a touch control sampling frequency determination module, configured for determining a touch control sampling frequency corresponding to the display device according to the display refresh frequency, wherein the touch control sampling frequency comprises a first sampling frequency corresponding to the first refresh frequency and a second sampling frequency corresponding to the second refresh frequency, and the second sampling frequency is greater than the first sampling frequency; and
a control module, configured for driving the display device to display an image according to the determined display refresh frequency, and for collecting touch control information according to the touch control sampling frequency.

In a third aspect, embodiments of the present disclosure provide a display device, including: a memory, a processor, and a program stored on the memory and executable by the processor; wherein is configured to read the program in the memory to implement the steps of the display control method as described above.

In a fourth aspect, embodiments of the present disclosure provide a readable storage medium, having a program stored thereon, the program, when being executed by a processor, implements the steps of the display control method as described above.

### BRIEF DESCRIPTION OF THE DRAWINGS

To illustrate the technical solutions of embodiments of the present disclosure more clearly, a brief description will be given below with reference to the accompanying drawings for the description of the embodiments of the present disclosure. Apparently, the following drawings are merely some embodiments of the present disclosure, and other drawings can be obtained by a person skilled in the art from these drawings without involving any creative effort.

FIG. 1 is a schematic flow diagram of a display control method provided by an embodiment of the present disclosure;

FIG. 2 is a timing sequence diagram for display and touch control provided by an embodiment of the present disclosure;

FIG. 3 is another schematic flow diagram of a display control method provided by an embodiment of the present disclosure;

FIG. 4 is a schematic diagram of a structure of a display device provided by an embodiment of the present disclosure;

FIG. 5 is a schematic diagram of a structure of a display device provided by an embodiment of the present disclosure.

### DETAILED DESCRIPTION

The following clearly and completely describes the technical solutions in the embodiments of this application with reference to the accompanying drawings in the embodiments of this application. Apparently, the described embodiments are some rather than all of the embodiments of this application. All other embodiments obtained by a person of ordinary skill in the art based on the embodiments of this application without creative efforts shall fall within the protection scope of this application.

The terms “first”, “second”, and the like in the embodiments of the disclosure are used for distinguishing similar objects and should not be interpreted as a particular sequence or chronological order. Moreover, the terms “include” and “comprise”, and any variation thereof, are intended to interpreted as a non-exclusive inclusion, such that a process, a method, a system, an article of manufacture, or an apparatus are not necessarily limited to include only those steps or elements expressly listed, but may also include other step or element which are not expressly listed or inherent to such process, method, system, article of manufacture, or apparatus. Furthermore, the use of term “and/or” in this application refers to at least one of elements which such term is present. For example, A and/or B and/or C, refers to the following seven instances: single A, single B, single C, both A and B, both B and C, both A and C, and all of A, B and C.

In the relevant art, certain time is required for pixel charging. In order to improve the display effect, a sufficiently high picture refresh frequency is required for the in-cell touch panel, and duration of a timing sequence for picture display needs to be increased accordingly. In addition, in order to improve the touch control precision, a sufficiently high touch control sampling frequency is required, and duration of a timing sequence for touch control sampling also needs to be increased accordingly.

For the in-cell touch panel, the timing sequences for picture display and touch control scanning conflict with each other, which may cause a certain limitation on the display effect of the display panel and the precision of the touch control sampling effect.

Embodiments of the present disclosure provide a display control method, applied to a display device. The display device may be a display device such as a notebook computer and an intelligent all-in-one machine, and the display device includes a display panel, and the display panel is specifically an in-cell touch display panel.

In step 101, a display refresh frequency of the display device is obtained.

In this embodiment, the display device is capable of providing different display refresh frequencies during use. To be specific, in one embodiment, the display refresh frequency includes a first refresh frequency and a second refresh frequency, the first refresh frequency is greater than the second refresh frequency.

It is to be understood that in the technical solution of the present embodiment, the display refresh frequency of the display device may be adjusted to meet different requirements for the display refresh frequency of the display device under different usage states.

Illustratively, in a case where a user plays a shooting game, there is a higher requirement for the real-time performance of the picture display, and the operation mode of the display device is a non-touch control display mode, and the operation mode corresponds to a higher display refresh frequency. In an example, the display refresh frequency may be 180 Hz.

Illustratively, in a case where a user watches a high definition video, there is a higher requirement for the picture quality and thus, a higher display refresh frequency is required. Meanwhile, the user may perform an operation such as pause and continue via touch control. In this case, the operation mode of the display device may be a third touch control display mode. In this operation mode, the display device supports a touch control function and has a relatively high display refresh frequency. In an example, the display refresh frequency may be 120 Hz.

Illustratively, in a case where a user browses a web page normally, the display refresh frequency may be 90 Hz and the touch control sampling frequency is 90 Hz.

Illustratively, in a case where a user draws a picture through a handwriting function, the picture is a substantially static picture. In this operation mode, a lower display refresh frequency may satisfy usage requirements. In an example, the display refresh frequency may be 60 Hz.

It is to be understood that the above-described display refresh frequency is for illustrative purposes only, and the specific values thereof are not limited thereto.

In step 102, a touch control sampling frequency corresponding to the display panel is determined according to the display refresh frequency.

In this embodiment, different touch control sampling frequencies are provided accordingly based on different requirements of the user for the touch control function.

The touch control sampling frequency includes a first sampling frequency corresponding to a first refresh frequency and a second sampling frequency corresponding to a second refresh frequency, and the second sampling frequency is greater than the first sampling frequency.

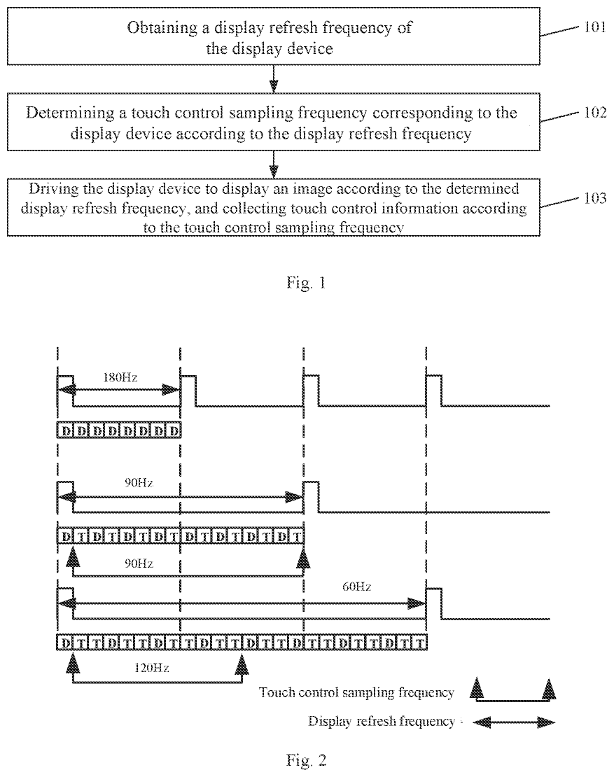

As shown in FIG. 2, illustratively, in a case where the user plays a shooting game, the display refresh frequency is 180 Hz. In this case, the user does not need to perform a touch control operation, and the corresponding touch control sampling frequency is 0.

Illustratively, in a third touch control display mode in which the user watches a high definition video, the display refresh frequency may be 120 Hz, and the user may need to use the touch control function, and the corresponding touch control sampling frequency is 60 Hz.

Illustratively, in a second touch control display mode in which the user browses a web page normally, the display refresh frequency may be 90 Hz, and the touch control sampling frequency is 90 Hz, such that both the picture quality and the touch control sampling effect can be ensured.

Illustratively, in a first touch control display mode in which the user is drawing through a handwriting function, the display refresh frequency may be 60 Hz, and the drawing process has a higher requirement for the real-time and accuracy of sampling a stylus trace. Therefore, the touch control sampling frequency is set to 120 Hz, which can significantly improve the precision and accuracy of the touch control sampling, thereby restoring the stylus trace more accurately.

It is to be understood that the above-described display refresh frequency is for illustrative purpose only, and the specific values thereof are not limited thereto.

In step 103, the display panel is driven to display an image according to the determined display refresh frequency, and touch control information is collected according to the touch control sampling frequency.

After the display refresh frequency and the touch control sampling frequency are determined, the display panel is controlled to display an image according to the determined display refresh frequency, and the touch control information is collected according to the determined touch control sampling frequency, so that the display effect and the touch control display effect satisfying the usage requirement can be obtained.

As shown in FIG. 1, in an embodiment, prior to the step 101, the method further includes: obtaining an operation mode of the display device.

Accordingly, the step 101 specifically includes: obtaining the display refresh frequency corresponding to the operation mode.

In the technical solution of the present embodiment, the display device has a plurality of different operation modes. In an embodiment, the display device has two operation modes, namely, a non-touch control display mode and a touch control display mode; in the non-touch control display mode, the touch control function of the display panel is in an off state; and in the touch control display mode, the display panel supports the touch control function.

In this embodiment, the operation mode of the display device may be determined in different ways.

In an exemplary embodiment, a corresponding operation mode may be selected based on an operation input of the user.

In an example in which the display device is a notebook computer or a personal computer, the user may switch the operation mode of the display panel through a specific physical key or virtual key; alternatively, the user may also switch the operation mode of the display panel in a specified control menu through a mouse, a keyboard, and the like; alternatively, the user may also provide the above-mentioned operation input through other manners such as a voice control, a remote control, a touch pad.

As the type of display device changes, adaptations can be made as needed. Illustratively, for some mobile phones or tablet computers, the control thereof relies on a touch control input, and different operation modes corresponding to the touch control display input may be selected by means of a touch control.

In some embodiments, the step of obtaining an operation mode of the display device includes:
determining that the operation mode of the display device is a non-touch control display mode in a case where any one of the following conditions is satisfied:
an operation input provided based on a first type of peripheral device is detected;
an operation input to turn off a touch control function is received; or
a first type of application is detected to be in a running state.

In some embodiments, the first type of peripheral device includes one or more of a mouse, a keyboard, or a game peripheral device.

In an exemplary embodiment, the display device is a notebook computer, and there is a small possibility that the touch control function is simultaneously used in a case where the user operates based on a mouse or a keyboard. Therefore, in this case, the operation mode of the display device may be switched to the non-touch control display mode.

Similarly, there is a small possibility that the touch control function is used by the user when the user is using a game pad, or a peripheral device for game simulator such as a steering wheel, an induction gun, or the like, the operation mode of the electronic device may be determined to be the non-touch control display mode.

In some other embodiments, the user may actively turn off the touch control function by using an operation input to enter the non-touch control display mode.

In some other embodiments, when a particular first type of application is running, the user is also less likely to use the touch control function. Illustratively, in a case where the user is playing a game or watching a high definition video, there is a higher requirement for the display effect, a higher refresh frequency for the picture is required, while there is a relatively less requirement for the touch control function. In some embodiments, the first type of application includes one or more of a game program and a video player. Thus, the display device enters into the non-touch control display mode when these first type of applications is running at the display device.

In some embodiments, the step of obtaining an operation mode of the display device includes:
determining that the operation mode of the display device is a touch control display mode in a case where any one of the following conditions is satisfied:
an active stylus is detected to be in an operation state;
an operation input for turning on a touch control function is received;
an action of a touch control input is detected by a camera;
a second type of application is detected to be in a running state.

In the technical solution of the present embodiment, in a case where it is detected that the active stylus is in the operation state, the user is likely to perform an operation based on the active stylus, and in the process of the user using the active stylus, the touch control function needs to be used.

In some other embodiments, whether the user performs the touch control operation may be determined by the camera based on image recognition.

It should be understood that if the display device is in the non-touch control display mode, the touch control operation performed the user may not be recognized by the display panel. Therefore, in the present embodiment, the action of the touch control input is captured by the camera so as to turn on the operation mode corresponding to the touch control display mode.

In some embodiments, the operation input of turning on the touch control function may not only refer to the above-mentioned embodiments, but also may be realized by means of a gesture instruction. Illustratively, in a case where the camera collects an action of a specific gesture, the display panel is controlled to enter the touch control display mode.

In some embodiments, whether to enter the touch control display mode may be determined by determining whether the second type of application is in the running state. In some embodiments, the second type of application includes one or more of a document processing program or a drawing program.

It is to be understood that the first type of application may include a game program, and the second type of application may also include a game program. For example, for a shooting game or a game of action type, if the real-time requirement for picture refreshing is high and the touch control input is generally not required, it is determined that such a game corresponds to the non-touch control display mode. For a game with a lower performance requirement such as a match-3 type game, it is determined that such a game corresponds to the second type of application. In implementation, the type of application shall be determined based on factors such as the application's requirements on hardware performance and display and input habits.

Illustratively, in a case where the user uses a drawing program, using the touch control input may be more convenient, and for this case, an operation mode corresponding to the touch control display mode is entered. For another example, in a case where the user uses a function such as a slide presentation, document presentation and the like, the background is a relatively static picture, and at the same time, the user may also input some comments or marks by handwriting. In this case, the refresh frequency requirement for the picture is relatively low, and the requirement for the touch control recognition is relatively high. A corresponding operation mode can be determined based on the above requirements.

In some embodiments, the operation modes include a non-touch control display mode corresponding to the first refresh frequency and a touch control display mode corresponding to the second refresh frequency.

In some of these embodiments, the first sampling frequency is 0, the first refresh frequency is greater than 0, the operation timing sequence of the display device includes a plurality of picture refresh periods arranged sequentially, and one frame of operation timing sequence of the display device corresponds to one picture refresh frame. It can be understood that, in this case, the touch control sampling function of the display panel is turned off.

In the non-touch control display mode, the display device can reach the highest display refresh frequency, and in this case, the display refresh frequency corresponding to the non-touch control display mode is the first refresh frequency, and the touch control sampling frequency corresponding to the non-touch control display mode is the first sampling frequency.

In another embodiment, the operation mode includes a plurality of touch control display modes corresponding to different display refresh frequencies. Specifically, each of touch control sampling frequencies is greater than 0, and each of the display refresh frequencies is greater than 0, the one frame of operation timing sequence of the display device includes picture refresh periods and touch control scanning periods which are arranged alternatively, and all the picture refresh periods in the one frame of operation timing sequence of the display device correspond to one picture refresh frame.

Illustratively, the plurality of touch control display modes may include a low refresh frequency mode having a lower display refresh frequency and a high refresh frequency mode having a higher display refresh frequency.

It is to be understood that the display panel may also include more than two operation modes, for example, the display panel may include three operation modes having different display refresh frequencies. Illustratively, the operation modes includes a low power consumption mode, a balance mode and a high performance mode, whose display refresh frequencies are from low to high.

It is to be understood that the name of the operation modes is not limited. Illustratively, the low power consumption mode may also be referred to as a power saving mode, and the high performance mode may also be referred to as a game mode.

It is to be understood that the number of operation modes of the display panel is not limited thereto and may be further increased. For example, four, five, six or even more operation modes are provided, which are not further defined and described herein.

In some other embodiments, the above-mentioned two modes may be combined. In particular, the display panel may include the touch control display mode in which the touch control function is turned on and the non-touch control display mode in which the touch control function is turned off, wherein each of the touch control display mode and the non-touch control display mode may include a plurality of operation modes having different display refresh frequencies.

Illustratively, for the touch control display mode, three operation modes with different display refresh frequencies are included, while the non-touch control display mode also includes three sub-operation modes with different display refresh frequencies. In this case, it is to be understood that the display panel includes six different operation modes.

In implementation, the number of sub-operation modes corresponding to the touch control display mode and the non-touch control display mode may be adjusted, and the number thereof is not limited thereto.

In an embodiment, the operation modes of the display panel specifically include one non-touch control display mode and three touch control display modes, namely, a first touch control display mode, a second touch control display mode and a third touch control display mode, and thus the display panel includes four operation modes in total. This is exemplified in the present embodiment.

In the non-touch control display mode, each frame of operation timing sequence is composed of a plurality of picture refresh periods which are continuously arranged, and each frame of operation timing sequence corresponds to one picture refresh frame.

In the touch control display mode, the one frame of operation timing sequence of the display device includes picture refresh periods and touch control scanning periods which are alternately arranged, and all the picture refresh periods in the one frame of operation timing sequence of the display device correspond to one picture refresh frame.

Further, in some embodiments, for the touch control display mode, in the first touch control display mode and the second touch control display mode, a ratio of duration of a picture refresh period to duration of a touch control scanning period in each frame of operation timing sequence of the display device is different.

In the technical solution of the present embodiment, in the non-touch control display mode, the first sampling frequency corresponding to the touch control sampling recognition is 0, in other words, the touch control sampling is in an off state.

In the touch control display mode, the operation timing sequence of the display panel includes picture refresh periods and touch control scanning periods, and the picture refresh periods and the touch control scanning periods are alternately set.

In the technical solution of the present embodiment, for different specific operation modes in a touch control display mode, the ratio of the picture refresh periods to the touch control scanning period is different.

As shown in FIG. 2, two adjacent dotted lines represent one frame of operation timing sequence corresponding to 180 Hz, wherein D represents picture refresh unit duration, and T represents a touch control scanning unit duration. For illustration, the exemplary touch control scanning unit duration and the picture refresh unit duration are equal.

An upper timing sequence diagram as shown in FIG. 2 corresponds to the non-touch control display mode, and the one frame operation timing sequence includes eight picture refresh units of duration arranged sequentially, and these eight picture refresh periods correspond to one picture refresh frame.

Illustratively, in the third touch control display mode in which the user watches the high definition video, the display refresh frequency may be 120 Hz, the touch control sampling frequency is 60 Hz, and the ratio of the duration of the picture refresh period to that of the touch control scanning period is 2:1.

Specifically, in the third touch control display mode, one frame operation timing sequence includes 12 units of duration; one picture refresh period corresponds to two picture refresh units of duration, and one touch control scanning period corresponds to one touch control scanning units of duration. That is to say, one unit of duration of touch control scanning is performed after every two units of duration of picture refresh being performed. 8 units of duration corresponds to a picture refresh frame or a touch control scanning frame, then the display refresh frequency can be 120 Hz, and the touch control sampling frequency is 60 Hz.

As shown in a middle timing sequence diagram in FIG. 2, illustratively, in the second touch control display mode in which the user is normally browsing a webpage, the display refresh frequency may be 90 Hz, and the touch control sampling frequency is 90 Hz, and a ratio of duration of a picture refresh period to that of a touch control scanning period is 1:1.

Specifically, one frame operation timing sequence includes 16 units of duration; one picture refresh period corresponds to one picture refresh unit duration; and one touch control scanning period corresponds to one touch control scanning unit duration. That is to say, one unit of duration of touch control scanning is performed after one unit duration of picture refresh being performed.

As shown in the bottom timing sequence diagram in FIG. 2, illustratively, in the first touch control display mode in which the user is drawing by using a handwriting function, the display refresh frequency may be 60 Hz, and the touch control sampling frequency is 120 Hz, and a ratio of duration of a picture refresh period to that of a touch control scanning period is 1:2.

Specifically, one frame operation timing sequence includes 24 units of duration. In the present embodiment, one picture refresh period corresponds to one picture refresh unit duration, and one touch control scanning period corresponds to two touch control scanning units of duration. That is to say, two units of duration of touch control scanning are performed after one unit duration of picture refresh being performed.

Obviously, in implementation, the ratio of the picture refresh period to the touch control scanning period can be adjusted as needed, and the numerical value thereof is not limited thereto.

In some embodiments, picture refresh periods included in each frame of operation timing sequence corresponds to one picture refresh frame, and touch control scanning periods included in each frame of operation timing sequence corresponds to m touch control scanning frames, wherein m is an integer or decimal number greater than 0.

Illustratively, the ratio of the duration of the picture refresh period to that of the touch control scanning period is 1:1.5. Each frame of operation timing sequence corresponds to one picture refresh frame, and two frame of operation timing sequences correspond to three touch control scanning frames.

In an example in which the display panel includes 1600 display scanning lines and 1600 touch control scanning lines, in the above-mentioned non-touch control display mode, the display panel is in a normal operation state and the maximum rated display refresh frequency is 180 Hz, a scanning time for a display scanning line is 1 (second)/180 (Hz)/1600 (lines)=3.47 microseconds.

The 3.47 microseconds may be understood as the shortest scanning time that can be used by the scanning line (specifically, a display scanning line or a touch control scanning line) of the display panel, namely, which corresponds to the above-mentioned one unit duration.

In other words, the scanning time for each display scanning line or touch control scanning line is 3.47 microseconds. As such, the touch control scanning frequency is 60 Hz in a case where the picture refresh frequency is 120 Hz; the touch control scanning frequency is 90 Hz in a case where the picture refresh frequency is 90 Hz.

In this way, in a case where the picture update speed needs to be improved or the picture display quality needs to be improved, an operation mode with a higher picture refresh frequency can be used, and in a case where there is a higher precision requirement for touch control sampling such as performing a recognition for handwriting stylus trace, an operation mode with a higher touch control sampling frequency is selected.

In some embodiments, the display device corresponds to the first touch control display mode in a case where the display refresh frequency of the display device is in a first refresh frequency range, and the display device corresponds to the second touch control display mode in a case where the display refresh frequency of the display device is in a second refresh frequency range, and the first refresh frequency range and the second refresh frequency range do not overlap.

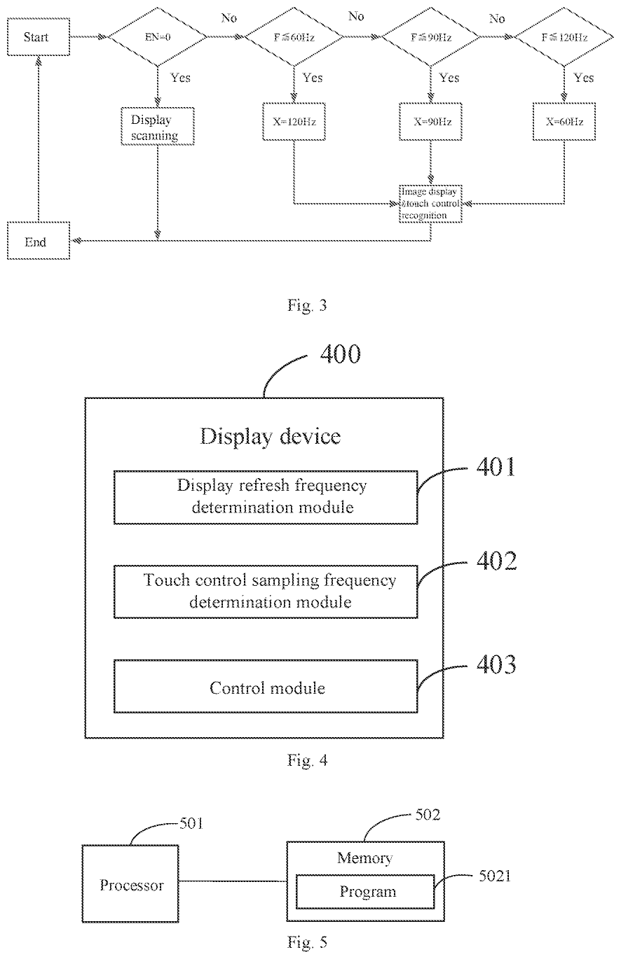

As shown in FIG. 3, in the technical solution of the present embodiment, each time when a frame of image is received, whether it is the touch control display mode can be detected at first. In the present embodiment, an identifier stored in a switch touch control register may be used to represent a touch control state. Illustratively, if the identifier EN=0, the identifier corresponds to the non-touch control display mode. Then, a display scanning is performed according to a display refresh frequency corresponding to a signal provided by a data source (such as a GPU) so as to display an image. In this case, the refresh frequency of the display panel can be increased to a highest state according to the requirement, so as to provide an optimal display effect.

If the identifier EN=1, this corresponds to a touch control display mode. In this case, the corresponding refresh frequency may be determined according to the signal provided by the data source.

Illustratively, if the picture refresh frequency F of the signal provided by the data source is less than or equal to 60 Hz, the touch control sampling frequency X is determined to be 120 Hz. If the picture refresh frequency F of the signal provided by the data source is greater than 60 Hz but less than or equal to 90 Hz, the touch control sampling frequency X is determined to be 90 Hz. If the picture refresh frequency F of the signal provided by the data source is greater than 90 Hz but less than or equal to 120 Hz, the touch control sampling frequency is determined to be 60 Hz. Thereafter, the image display and touch control recognition are performed according to the determined display refresh frequency and the touch control sampling frequency.

The ranges, i.e., less than or equal to 60 Hz, greater than 60 Hz but less than or equal to 90 Hz, and greater than 90 Hz but less than or equal to 120 Hz are examples for the above mentioned different refresh frequency ranges.

It is to be understood that the above values are for illustrative purposes only and are not intended to be limiting.

Embodiments of the present disclosure provide a display device, applied to a display device including a display panel.

In some embodiments, the display device 400 includes the following modules.

A display refresh frequency determination module 401, configured for obtaining a display refresh frequency of the display device, wherein the display refresh frequency includes a first refresh frequency and a second refresh frequency, and the first refresh frequency is greater than the second refresh frequency;

A touch control sampling frequency determination module 402, configured for determining a touch control sampling frequency corresponding to the display device according to the display refresh frequency, wherein the touch control sampling frequency includes a first sampling frequency corresponding to the first refresh frequency and a second sampling frequency corresponding to the second refresh frequency, and the second sampling frequency is greater than the first sampling frequency;

A control module 403, configured for driving the display device to display an image according to the determined display refresh frequency, and collecting touch control information according to the touch control sampling frequency.

In some embodiments, the first sampling frequency is 0, the first refresh frequency is greater than 0, and in the case where the refresh frequency is the first refresh frequency, the operation timing sequence of the display device includes a plurality of picture refresh periods arranged sequentially, and the one frame of operation timing sequence of the display device corresponds to one picture refresh frame.

In some embodiments, the touch control sampling frequency is greater than 0, the display refresh frequency is greater than 0, and the one frame of operation timing sequence of the display device includes picture refresh periods and touch control scanning periods which are alternately arranged, and all the picture refresh periods in the one frame of operation timing sequence of the display device correspond to one picture refresh frame.

In some embodiments, the display device further includes an operation mode acquisition module.

The operation mode acquisition module is configured for obtaining a operation mode of the display device;

The display refresh frequency determination module 401 is specifically configured for obtaining the display refresh frequency corresponding to the operation mode.

In some embodiments, the operation mode acquisition module is specifically configured for:
determining that the operation mode of the display device is a non-touch control display mode in a case where any one of the following conditions is satisfied:
an operation input provided from a first type of peripheral device is detected;
an operation input to turn off a touch control function is received;
a first type of application is detected to be in a running state.

In some embodiments, the first type of peripheral device includes one or more of a mouse, a keyboard, and a game peripheral device.

In some embodiments, the first type of application includes one or more of a game program and a video player.

In some embodiments, the operation mode acquisition module is specifically used for:
determining that the operation mode of the display device is a touch control display mode in a case where any one of the following conditions is satisfied:
an active stylus is detected to be in an operation state;
an operation input for turning on a touch control function is detected;
an action of a touch control input is detected by a camera;
a second type of application is detected to be in a running state.

In some embodiments, the second type of application includes one or more of a document processing program and a drawing program.

In some embodiments, the touch control display mode includes a first touch control display mode and a second touch control display mode, a touch control sampling frequency corresponding to the first touch control display mode and a touch control sampling frequency corresponding to the second touch control display mode are both greater than 0, and a display refresh frequency corresponding to the first touch control display mode and a display refresh frequency corresponding to the second touch control display mode are different.

In some embodiments, the display device corresponds to the first touch control display mode in a case where the display refresh frequency of the display device is in a first refresh frequency range, and the display device corresponds to the second touch control display mode in a case where the display refresh frequency of the display device is in a second refresh frequency range, and the first refresh frequency range and the second refresh frequency range do not overlap.

In some embodiments, in the first touch control display mode and the second touch control display mode, a ratio of duration of a picture refresh period to duration of a touch control scanning period in each frame of operation timing sequence of the display device is not equal.

In some embodiments, the display refresh frequency corresponding to the first touch control display mode is greater than the display refresh frequency corresponding to the second touch control display mode, and in each frame of operation timing sequence of the display device, a ratio for a touch control scanning period corresponding to the first touch control display mode is less than a ratio for a touch control scanning period corresponding to the second touch control display mode.

The display device 400 of the present embodiment is capable of implementing the steps of the above-described display control in the embodiments for the method and achieving substantially the same technical effects, and the detailed description thereof is omitted herein.

Embodiments of the present disclosure also provide a display device. Referring to FIG. 5, a display device may include a display panel, a processor 501, a memory 502, and a program 5021 is stored on the memory 502 and executable by the processor 501.

The program 5021, when being executed by the processor 501, implements any of the steps of the embodiments for the method as described above and achieves the same technical effects, and the detailed description thereof is omitted herein.

Those skilled in the art will appreciate that all or a portion of the steps for implementing the methods of the embodiments described above may be performed by hardware associated with program instructions, which may be stored on a readable medium.

The embodiments of the present disclosure also provide a readable storage medium having stored thereon a computer program which, when executed by a processor, can implement any of the above-mentioned method embodiments and achieve the same technical effects, and in order to avoid repetition, the description thereof will not be repeated.

The storage medium, such as Read-Only Memory (ROM), Random Access Memory (RAM), magnetic disk or optical disk, etc.

It should be noted that the above division of various modules is only a division of logical functions, which modules may be integrated in whole or in part into one physical entity or may be physically separated in practical implementation. These modules can all be realized in the form of software being invoked by a processing unit; these modules may also be implemented entirely in form of hardware; it is also possible that parts of the modules are implemented in the form of processing units invoking software and parts of the modules are implemented in the form of hardware. For example, the determination module may be a separate processing unit, or may be integrated in a certain chip of the above-mentioned device, or may be stored in the memory of the above-mentioned device in the form of a program code, and a certain processing element of the above-mentioned device invokes and executes the functions of the above-mentioned determination module. Other modules are similarly implemented. Moreover, all or portions of the modules may be integrated together or implemented independently. The processing element described herein may be an integrated circuit having signal processing capabilities. In implementation, the steps of the above-described method or modules may be performed by instructions in the form of integrated logic circuits in hardware or software in a processor element.

For example, each module, unit, sub-unit, or sub-module may be one or more integrated circuits configured to implement the above methods, such as: one or more specific integrated circuits (Application Specific Integrated Circuit, ASIC), or, one or more microprocessors (digital signal processor, DSP), or, one or more field programmable gate arrays (Field Programmable Gate Array, FPGA), etc. As another example, when the above module is implemented in the form of a processing unit that schedules program code, the processing unit may be a general-purpose processor, such as a Central Processing Unit (CPU) or other processors that can invoke program code. As another example, the modules may be integrated together and implemented as a system-on-a-chip (SOC).

The foregoing is the exemplary embodiment of the present disclosure, it should be noted that for those of ordinary skill in the art, various improvements and modifications may be made without departing from the principles described in the present disclosure, and these improvements and modifications fall within the protection scope of the present disclosure.

1. A display control method, applied to a display device, the method comprising steps of:
obtaining a display refresh frequency of the display device, wherein the display refresh frequency comprises a first refresh frequency and a second refresh frequency, and the first refresh frequency is greater than the second refresh frequency;
determining a touch control sampling frequency corresponding to the display device according to the display refresh frequency, wherein the touch control sampling frequency comprises a first sampling frequency corresponding to the first refresh frequency and a second sampling frequency corresponding to the second refresh frequency, and the second sampling frequency is greater than the first sampling frequency; and
driving the display device to display an image according to the determined display refresh frequency, and collecting touch control information according to the touch control sampling frequency.

2. The method according to claim 1, wherein the first sampling frequency is 0, the first refresh frequency is greater than 0, and in a case where the refresh frequency is the first refresh frequency, an operation timing sequence of the display device comprises a plurality of picture refresh periods arranged sequentially, and one frame of operation timing sequence of the display device corresponds to one picture refresh frame.

3. The method according to claim 1, wherein the touch control sampling frequency is greater than 0, the display refresh frequency is greater than 0, and one frame of operation timing sequence of the display device comprises picture refresh periods and touch control scanning periods which are alternately arranged, and all the picture refresh periods in the one frame of operation timing sequence of the display device correspond to one picture refresh frame.

4. The method according to claim 1, wherein before the obtaining a display refresh frequency of the display device, the method further comprises:
obtaining an operation mode of the display device; and
the obtaining a display refresh frequency of the display device comprises:
obtaining the display refresh frequency corresponding to the operation mode.

5. The method according to claim 4, wherein the obtaining an operation mode of the display device comprises:
determining that the operation mode of the display device is a non-touch control display mode in a case that one of the following conditions is satisfied:
an operation input provided based on a first type of peripheral device is detected;
an operation input to turn off a touch control function is received; or
a first type of application is detected to be in a running state.

6. The method according to claim 5, wherein the first type of peripheral device comprises one or more of the following: a mouse, a keyboard, or a game peripheral device.

7. The method according to claim 5, wherein the first type of application comprises one or more of a game program or a video player.

8. The method according to claim 4, wherein the obtaining an operation mode of the display device comprises:
determining that the operation mode of the display device is a touch control display mode in a case that one of the following conditions is satisfied:
an active stylus is detected to be in an operation state;
an operation input for turning on a touch control function is detected;
an action of a touch control input is detected by a camera; or
a second type of application is detected to be in a running state.

9. The method according to claim 8, wherein the second type of application comprises one or more of a document processing program and a drawing program.

10. The method according to claim 8, wherein the touch control display mode comprises a first touch control display mode and a second touch control display mode, a touch control sampling frequency corresponding to the first touch control display mode and a touch control sampling frequency corresponding to the second touch control display mode are both greater than 0, and a display refresh frequency corresponding to the first touch control display mode and a display refresh frequency corresponding to the second touch control display mode are different.

11. The method according to claim 10, wherein the display device is in the first touch control display mode in a case that the display refresh frequency of the display device is in a first refresh frequency range, and the display device is in the second touch control display mode in a case that the display refresh frequency of the display device is in a second refresh frequency range, and the first refresh frequency range and the second refresh frequency range do not overlap.

12. The method according to claim 10, wherein, for the first touch control display mode and the second touch control display mode, a ratio of duration of a picture refresh period to duration of a touch control scanning period in each frame of operation timing sequence of the display device is different.

13. The method according to claim 12, wherein a display refresh frequency corresponding to the first touch control display mode is greater than a display refresh frequency corresponding to the second touch control display mode, and in each frame of operation timing sequence of the display device, a ratio for a touch control scanning period corresponding to the first touch control display mode is less than a ratio for a touch control scanning period corresponding to the second touch control display mode.

14. (canceled)

15. A display device, comprising: a memory, a processor, and a program stored on the memory and executable by the processor; wherein the processor is configured to read the program in the memory to perform:
obtaining a display refresh frequency of the display device, wherein the display refresh frequency comprises a first refresh frequency and a second refresh frequency, and the first refresh frequency is greater than the second refresh frequency;
determining a touch control sampling frequency corresponding to the display device according to the display refresh frequency, wherein the touch control sampling frequency comprises a first sampling frequency corresponding to the first refresh frequency and a second sampling frequency corresponding to the second refresh frequency, and the second sampling frequency is greater than the first sampling frequency; and
driving the display device to display an image according to the determined display refresh frequency, and collecting touch control information according to the touch control sampling frequency.

16. (canceled)

17. The display device according to claim 15, wherein before the obtaining a display refresh frequency of the display device, the processor is further configured to perform:
obtaining an operation mode of the display device; and
the step of obtaining a display refresh frequency of the display device comprises:
obtaining the display refresh frequency corresponding to the operation mode.

18. The display device according to claim 17, wherein the obtaining an operation mode of the display device comprises:
determining that the operation mode of the display device is a non-touch control display mode in a case that one of the following conditions is satisfied:
an operation input provided based on a first type of peripheral device is detected;
an operation input to turn off a touch control function is received; or
a first type of application is detected to be in a running state.

19. The display device according to claim 17, wherein the obtaining an operation mode of the display device comprises:
determining that the operation mode of the display device is a touch control display mode in a case that one of the following conditions is satisfied:
an active stylus is detected to be in an operation state;
an operation input for turning on a touch control function is detected;
an action of a touch control input is detected by a camera; or
a second type of application is detected to be in a running state.

20. A non-transitory readable storage medium, having a program stored thereon, the program, when being executed by a processor, cause the processor to perform:
obtaining a display refresh frequency of the display device, wherein the display refresh frequency comprises a first refresh frequency and a second refresh frequency, and the first refresh frequency is greater than the second refresh frequency;
determining a touch control sampling frequency corresponding to the display device according to the display refresh frequency, wherein the touch control sampling frequency comprises a first sampling frequency corresponding to the first refresh frequency and a second sampling frequency corresponding to the second refresh frequency, and the second sampling frequency is greater than the first sampling frequency; and
driving the display device to display an image according to the determined display refresh frequency, and collecting touch control information according to the touch control sampling frequency.

21. The non-transitory readable storage medium according to claim 20, wherein the program, when being executed by a processor, cause the processor to further perform the following step before the obtaining a display refresh frequency of the display device:
obtaining an operation mode of the display device; and
the obtaining a display refresh frequency of the display device comprises:
obtaining the display refresh frequency corresponding to the operation mode.

22. The non-transitory readable storage medium according to claim 21, wherein the obtaining an operation mode of the display device comprises:
determining that the operation mode of the display device is a non-touch control display mode in a case that one of the following conditions is satisfied:
an operation input provided based on a first type of peripheral device is detected;
an operation input to turn off a touch control function is received; or
a first type of application is detected to be in a running state;
or
determining that the operation mode of the display device is a touch control display mode in a case that one of the following conditions is satisfied:
an active stylus is detected to be in an operation state;
an operation input for turning on a touch control function is detected;
an action of a touch control input is detected by a camera; or
a second type of application is detected to be in a running state.
